(19) United States
(12) Patent Application Publication
(10) Pub. No.: US 2014/0115264 A1
(43) Pub. Date: Apr. 24, 2014

(54) MEMORY DEVICE, PROCESSOR, AND CACHE MEMORY CONTROL METHOD

(71) Applicant: FUJITSU LIMITED, Kawasaki-shi (JP)

(72) Inventor: Yuji SHIRAHIGE, Kawasaski (JP)

(73) Assignee: FUJITSU LIMITED, Kawasaki-shi (JP)

(21) Appl. No.: 14/018,464

(22) Filed: Sep. 5, 2013

(30) Foreign Application Priority Data
Oct. 24, 2012 (JP) 2012-235109

(51) Int. Cl. G06F 12/08

(52) U.S. Cl. CPC G06F 12/0862
USPC 711/137

(57) ABSTRACT

A memory device includes a plurality of ways; a register configured to hold an access history of accessing the plurality of ways; and a way control unit configured to select one or more ways among the plurality of ways according to an access request and the access history, put the selected one or more ways in an operation state, and put one or more of the plurality of ways other than the selected one or more ways in a non-operation state. The way control unit dynamically changes a number of the one or more ways to be selected, according to the access request.

### CROSS-REFERENCE TO RELATED APPLICATION

This patent application is based upon and claims the benefit of priority of the prior Japanese Patent Application No. 2012-235109 filed on Oct. 24, 2012, the entire contents of which are incorporated herein by reference.

### FIELD

The embodiments discussed herein are related to a memory device, a processor, and a cache memory control method.

### BACKGROUND

In order to improve the power efficiency of the entire system, it is important to reduce the power consumption of the processor that consumes a large amount of the power in the system. Methods for reducing the power consumption while minimizing the impact on performance are being explored. As a method of saving power in a cache RAM (Random access memory) used as a storage element of the cache memory built in the processor, a method of stopping the clock supply to a RAM chip and a RAM module that are not being used, and a method of turning off the chip enable, have been studied. For example, there is a method of realizing low power consumption by identifying a way that is predicted to operate in the cache, and operating only the predicted way by memory enable signals (see, for example, Patent Document 1).

In a case where ways other than the predicted way are not operated, when the prediction is missed, the cache operation is to be repeatedly performed, which decreases the performance. In order to reduce the power consumption while minimizing such a decrease in the performance, the maintenance of performance and the reduction of power consumption are preferably balanced.

Patent Document 1: Japanese Laid-Open Patent Publication No. 2002-328839

### SUMMARY

According to an aspect of the embodiments, a memory device includes a plurality of ways; a register configured to hold an access history of accessing the plurality of ways; and a way control unit configured to select one or more ways among the plurality of ways according to an access request and the access history, put the selected one or more ways in an operation state, and put one or more of the plurality of ways other than the selected one or more ways in a non-operation state, wherein the way control unit dynamically changes a number of the one or more ways to be selected, according to the access request.

The object and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIG. 1 illustrates an example of a configuration of a processing system;

FIG. 2 illustrates an example of a configuration of an instruction cache;

FIG. 3 illustrates an example of a pipe line operation of the instruction cache;

FIG. 4 illustrates an example of a configuration of a way predicting unit;

FIG. 5 illustrates an example of a configuration of a power save unit;

FIG. 6 illustrates an example of a configuration of a mode determining unit;

FIG. 7 illustrates an example of operation control of a cache RAM; and

FIG. 8 is a flowchart indicating an example of an operation of an instruction cache.

### DESCRIPTION OF EMBODIMENTS

Preferred embodiments of the present invention will be explained with reference to accompanying drawings.

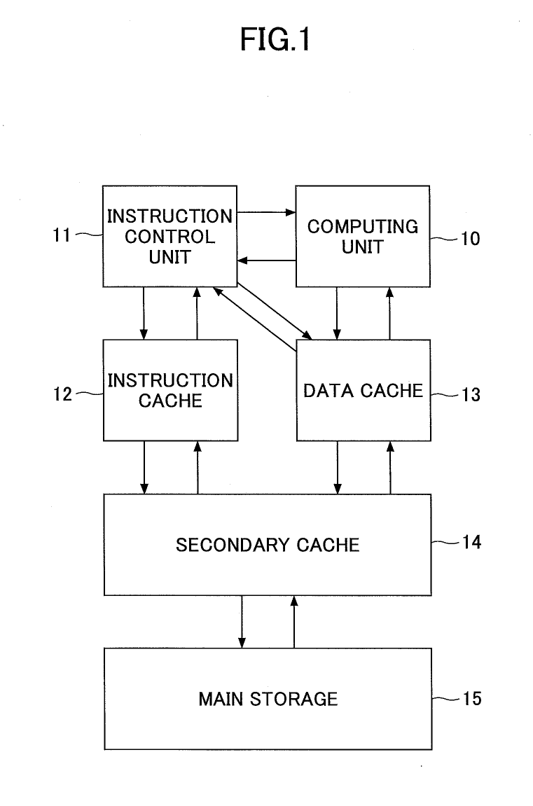

FIG. 1 illustrates an example of a configuration of a processing system. The processing system illustrated in FIG. 1 includes a computing unit 10, an instruction control unit 11, an instruction cache 12, a data cache 13, a secondary cache 14, and a main storage unit 15. The part including the computing unit 10, the instruction control unit 11, the instruction cache 12, the data cache 13, and the secondary cache 14 corresponds to a processor, and this processor performs processing based on the data in the main storage unit 15. In FIG. 1, the boundary between each function block and another function block indicated by boxes basically indicates a functional boundary; the boundary does not correspond to a separation in the physical positions, a separation in electric signals, or a separation in the control logic. Each functional block may be a single hardware module that is relatively physically separated from another block, or each functional block may indicate a single function in a hardware module in which the functional block is physically combined with another block.

The instruction control unit 11 issues, for the instruction cache 12, an instruction fetch request (access request) for fetching an instruction from the instruction cache 12. In response to the instruction fetch request, the instruction cache 12 supplies, to the instruction control unit 11, an instruction to be stored in the requested address. The instruction control unit 11 decodes the instruction fetched from the instruction cache 12, and controls the execution of a computing instruction by the computing unit 10 according to the decoding result. Furthermore, the instruction control unit 11 issues an access request such as a load instruction and a store instruction for the data cache 13, and executes the loading of data and the storing of data in a primary cache memory.

The instruction cache 12 and the data cache 13 are a primary cache memory. The primary cache memory, the secondary cache 14, and the main storage unit 15 form a memory hierarchy structure. When an access to the instruction cache 12 or the data cache 13, which is the primary cache memory, is not hit, access to the secondary cache 14, which is a lower level memory, is executed. Furthermore, when access to the secondary cache 14 is not hit, accesses to the main storage unit 15, which is a lower level memory, is executed. As described above, in a case of a cache miss, access is made to a lower level memory, and data that is the object of access stored in the lower level memory is transferred to a cache line corresponding to the cache memory. In this case, when there is valid cache data in all of the ways of the corresponding index, replace is executed, so that the data of the lowest priority (for example, data that has not been accessed for the longest time since the last access) is replaced with the data of the access object.

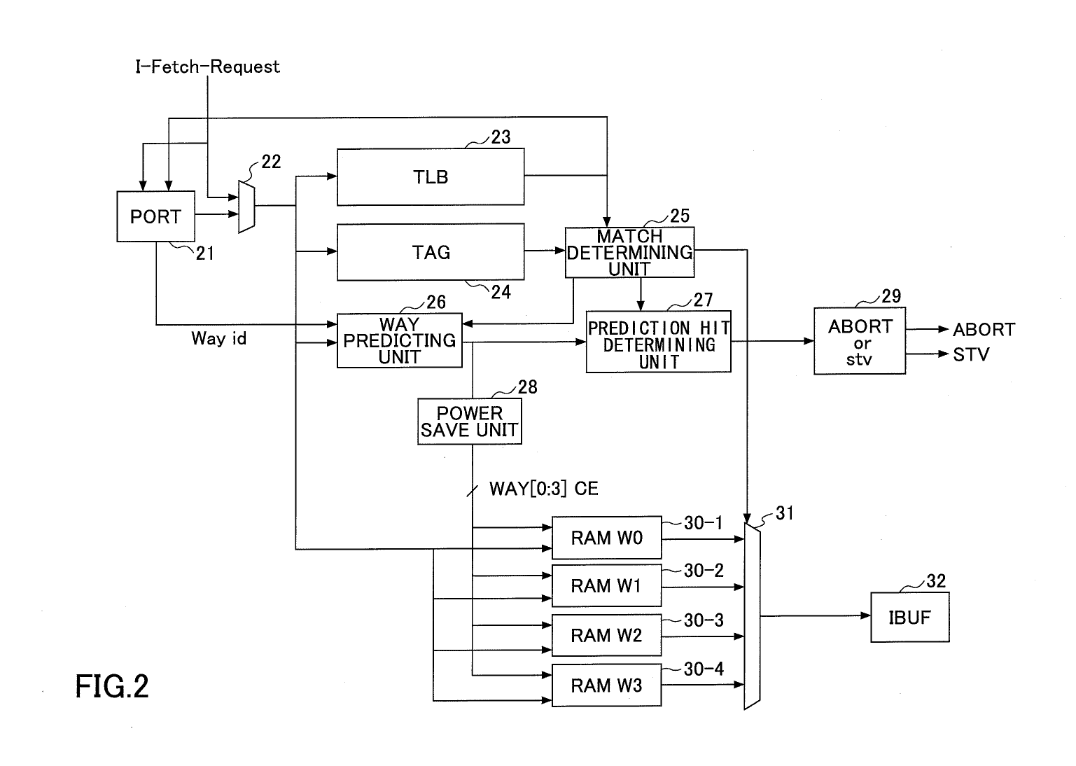

FIG. 2 illustrates an example of a configuration of the instruction cache 12. In the following, the instruction cache 12 is taken as an example to describe the configuration and the operations of the memory device; however, this is merely an example. Instead of the instruction cache 12, the data cache 13 or the secondary cache 14 may be used as the memory device having the same configuration and executing the same operations.

The instruction cache 12 illustrated in FIG. 2 includes a port 21, a selector 22, a TLB (Translation Lookaside Buffer) unit 23, a tag unit 24, a match determining unit 25, a way predicting unit 26, a prediction hit determining unit 27, a power save unit 28, and an abort report unit 29. The instruction cache 12 further includes cache RAMs 30-1 through 30-4 (RAM W0 through RAM W3), a selector 31, and an instruction buffer 32 (IBUF).

The instruction cache 12 includes a plurality of cache lines, and the copying of information from a lower level memory to the instruction cache 12 is executed in units of cache lines. The memory space of the main storage unit 15 is divided in units of cache lines, and the divided memory areas are sequentially allocated to cache lines. The capacity of the instruction cache 12 is smaller than that of the main storage unit 15, and therefore the memory area of the main storage unit 15 may be repeatedly allocated to the same cache line.

Generally, among all bits of an address, a predetermined number of lower level bits are the index of the cache memory, and the remaining bits at higher levels than the index are the tag of the cache memory. The tag unit 24 stores tags corresponding to these indices. In the instruction cache 12 illustrated in FIG. 2, it is assumed that there is a four way configuration including four ways. Accordingly, for each index, four tags corresponding to four ways are stored. The instruction cache 12 saves part of the data stored in the main storage unit 15 in the plurality of cache lines provided in each of the plurality of ways.

When the access request (I-Fetch-Request) comes, the access request is stored in the port 21, and an address indicating the access destination in the access request is sent out via the selector 22. This address is supplied to the TLB unit 23, the tag unit 24, the way predicting unit 26, and the cache RAMs 30-1 through 30-4. The TLB unit 23 converts a virtual address of an access destination to a physical address. The tag unit 24 uses the index part of the address to output a tag of the corresponding index in the tag unit 24. It is assumed that there are four ways, and therefore four tags are output.

The match determining unit 25 compares the four tags output by the tag unit 24 with the tag part of the physical address obtained as a result of the conversion by the TLB unit 23, and determines whether the bit patterns of these tags match. The match determining unit 25 outputs a way ID identifying the way of the matching tag, i.e., a hit way. When any one of the four tags output by the tag unit 24 matches the tag part of the physical address, the access is determined to be a cache hit. When none of the four tags output by the tag unit 24 matches the tag part of the physical address, the access is determined to be a cache miss. As described above, the match determining unit 25 identifies a hit way matching the access destination among the plurality of ways according to the access request. The way ID of the identified hit way is supplied from the match determining unit 25 to the port 21 and stored, and is also supplied to the way predicting unit 26, the prediction hit determining unit 27, and the selector 31.

The cache RAMs 30-1 through 30-4 are respectively provided in association with the four ways. As described below, among the cache RAMs 30-1 through 30-4, one or more cache RAMs selected by the power save unit 28 are operated, and the remaining cache RAMs are put in a non-operation state. That is to say, among the four ways, only the selected way is put in an operation state. The cache RAMs 30-1 through 30-4 that are in the operation state output data corresponding to the index in the address supplied from the selector 22. The selector 31 selects output data of a way matching a way ID of the hit way supplied from the match determining unit 25. For example, when the 0th way is the hit way, the output data of the 0th cache RAM 30-1 is selected by the selector 31. The selected output data is stored in the instruction buffer 32. When the cache RAM corresponding to the hit way is in a non-operation state, the abort report unit 29 reports the abort to the instruction control unit 11 as described below, and therefore the instruction control unit 11 does not refer to the value stored in the instruction buffer 32. When the cache RAM corresponding to the hit way is in an operation state, the abort report unit 29 reports STV to the instruction control unit 11 as described below, and therefore the instruction control unit 11 refers to the value stored in the instruction buffer 32.

As described above, in the case of a cache hit, the cache data that has been hit is supplied to the instruction control unit 11. In the case of a cache miss, the data that is the object of the access stored in the secondary cache 14 or the main storage unit 15 is transferred to the corresponding cache line in the instruction control unit 11.

The way predicting unit 26 includes a register for holding the access history of accessing a plurality of ways. This access history is stored in the register for each index. According to the index part of the address of the access destination supplied from the selector 22, the way predicting unit 26 outputs an access history corresponding to the index (the access object index). This access history includes arrangement order information indicating the arrangement order in which a plurality of ways (four ways in this example) are arranged in the order of the time that each way is accessed last with respect to the index. That is to say, when four ways W0, W1, W2, W3 are accessed in the temporal order of, for example, W2, W1, W0, W3 with respect to the index, information indicating this arrangement order (W2, W1, W0, W3) is included in the access history. In other words, by checking the access history, the order in which the four ways have been accessed in the past is known. The access history output from the way predicting unit 26 is supplied to the prediction hit determining unit 27 and the power save unit 28. The access history held by the register in the way predicting unit 26 is updated based on the way ID of the hit way from the match determining unit 25.

The power save unit 28 selects one or more ways among the plurality of ways (four ways in this example), according to the access history of the access object index supplied from the way predicting unit 26. Specifically, in a state where an N number of ways is specified as the number of ways to be selected, N ways that have been accessed most recently among the plurality of ways (four ways in this example), are selected. That is to say, in the arrangement order indicated by the access history that has been supplied, N ways that have been accessed most recently are sequentially selected from the way of the newest access. The power save unit 28 supplies the chip enable signal WAY[0:3]CE to the cache RAMs 30-1 through 30-4, to operate the selected N ways and put the ways other than the selected way(s) in a non-operation state. In this example, the operation and non-operation of the cache RAMs 30-1 through 30-4 are controlled by chip enable signals; however, the operation and non-operation of the cache RAMs may be controlled by turning on and off the supply of clock signals to the cache RAMs.

A mode determining unit included in the way predicting unit 26 or the power save unit 28 determines the number N of ways to be selected according to the access history and the hit way. Specifically, the mode determining unit may identify the ranking of the hit way defined by the access request in the arrangement order (the arrangement order indicated by the access history) from the way of the newest access time (for example, the Mth way), and set this identified number M as the number N of ways to be selected.

As described above, the way predicting unit 26 and the power save unit 28 function as a way control unit for controlling the operation and the non-operation based on way prediction. That is to say, as described above, the way control unit selects one or more (an N number of) ways from the plurality of ways according to the access request including the address of the access destination and the access history, operates the selected ways, and puts the ways other than the selected ways in a non-operation state. Then, the mode determining unit included in this way control unit dynamically changes the number N of ways to be selected, according to the access request (more specifically, according to the hit way defined by the access request).

The prediction hit determining unit 27 determines whether the prediction is hit, according to the information identifying the cache RAM in an operation state from the power save unit 28 and the way ID of the hit way from the match determining unit 25. As described below, the operation of selecting one or more ways (prediction operation) by the way control unit (way predicting unit 26 and power save unit 28) is executed before the time of the operation of identifying the hit way executed by the match determining unit 25. Therefore, the cache RAM is put in an operation state in advance based on the prediction and is caused to output data, and when the hit way is identified by the match determining unit 25, the selector 31 immediately selects the data of the hit way, so that high-speed reading of cache data is realized. When one of the cache RAMs put in an operation state is a hit way, the prediction hit determining unit 27 determines that the prediction is hit. When none of the cache RAMs put in an operation state is a hit way, the prediction hit determining unit 27 determines that the prediction is missed.

The abort report unit 29 outputs an abort signal or an STV signal based on the hit determination by the prediction hit determining unit 27. In the case of hit determination (prediction is hit), the abort report unit 29 outputs an STV signal. In response to the STV signal, the instruction control unit 11 refers to the data of the instruction buffer 32. In the case of miss determination (prediction is missed), the abort report unit 29 outputs an abort signal. According to the abort signal, the instruction control unit 11 recognizes that the cache data is not prepared yet.

When abort is reported from the abort report unit 29, the instruction cache 12 executes the operation of reading the cache RAM again, based on the access request stored in the port 21 and the way ID of he hit way stored in the port 21. In this case, the address of the access destination in the access request stored in the port 21 is supplied, via the selector 22, to the TLB unit 23, the tag unit 24, the way predicting unit 26, and the cache RAMs 30-1 through 30-4. Furthermore, the way ID of the hit way stored in the port 21 is supplied to the way predicting unit 26. The way control unit including the way predicting unit 26 and the power save unit 28 generates a chip enable signal WAY[0:3]CE so that only the cache RAM corresponding to the way ID of the hit way is operated. Accordingly, in the second cache reading operation, the data is reliably read by using the information of the hit way.

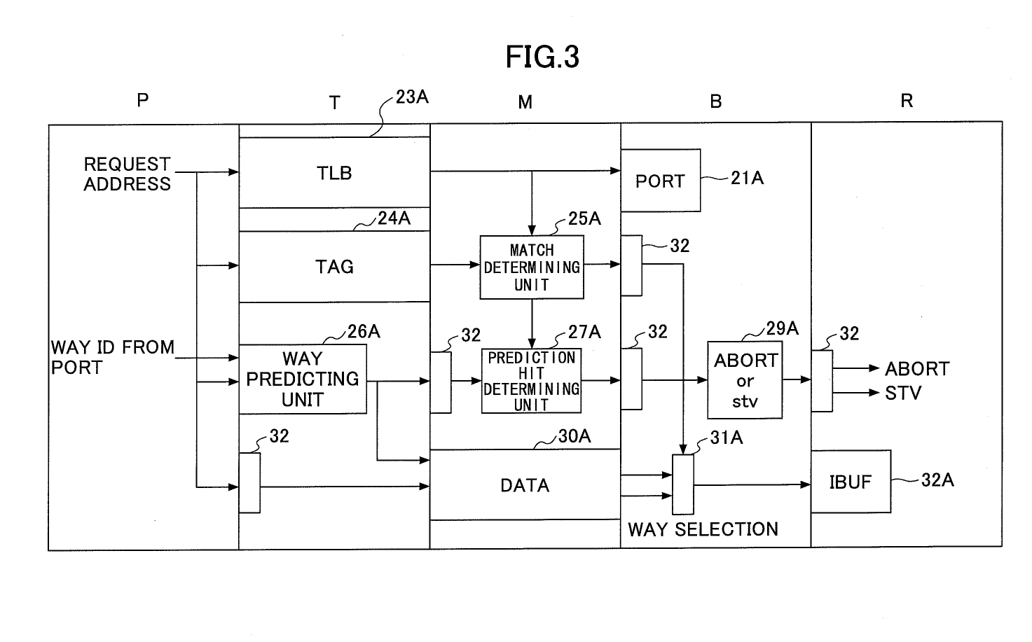

FIG. 3 illustrates an example of a pipe line operation of the instruction cache. As illustrated in FIG. 3, the cache reading operation includes five cycles of P, T, M, B, and R. In cycle P, a request address is supplied. In the first cache reading operation (that is to say, the first cache reading operation that is not a cache reading operation after the abort), a way ID is not supplied from the port.

In cycle T, a TLB address conversion operation 23A performed by the TLB unit 23, a tag reading operation 24A performed by the tag unit 24, and a way prediction operation 26A performed by the way predicting unit 26 and the power save unit 28, are executed. In FIG. 3, the respective elements 32 indicate data latch operations by flip flop.

In cycle M, a match determining operation 25A performed by the match determining unit 25, a prediction hit determining operation 27A performed by the prediction hit determining unit 27, and a data reading operation 30A performed by the cache RAMs 30-1 through 30-4, are executed. As described above, the way prediction operation 26A performed by the way control unit (way predicting unit 26 and power save unit 28) is executed in a cycle before the match determining operation 25A performed by the match determining unit 25. Therefore, by putting the cache RAM in an operation state in advance based on the prediction, it is possible to execute the data reading operation 30A of reading the data from the cache RAM put in the operation state based on the prediction, in parallel with the match determining operation 25A performed by the match determining unit In cycle B, a port storing process 21A of storing, in the port 21, the way ID of the hit way identified by the match determining operation 25A, a data selecting process 31A of selecting data of the hit way performed by the selector 31, and an abort reporting process 29A performed by the abort report unit 29, are executed. In the last cycle R, the sending of an abort signal or a STV signal, and a data storing process 32A of storing data in the instruction buffer 32, are executed.

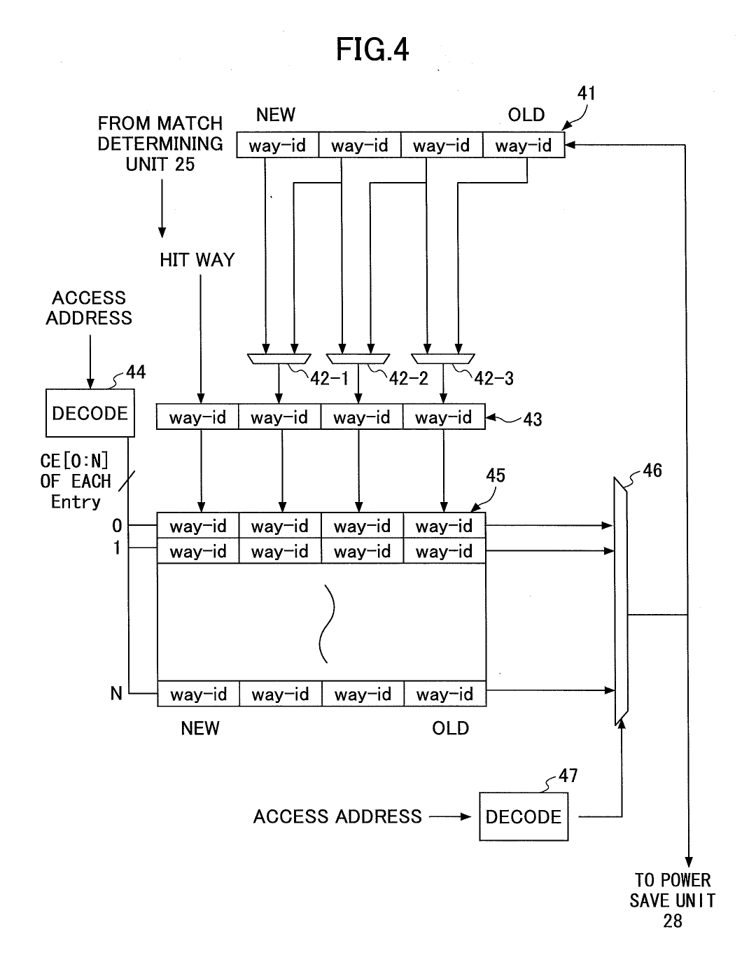

FIG. 4 illustrates an example of a configuration of the way predicting unit 26. The way predicting unit 26 includes a temporary storage register 41, selectors 42-1 through 42-3, a temporary storage register 43, a decoder 44, an access history register 45, a selector 46, and a decoder 47.

The access history register 45 holds access history of accessing a plurality of ways. The access history is stored in each of the indices (1 through N). In the access history, a plurality of ways (four ways in this example) are arranged in the order of the time when each way has been accessed last, for each index. In FIG. 4, among the four way IDs that are arranged, the way indicated by the leftmost way ID is the way that has been accessed most recently, and the way indicated by the rightmost way ID is the way that has been accessed least recently.

The decoder 44 decodes the index part of the address of the access destination supplied from the selector 22, and generates a chip enable signal CE[0:N] to enable only the access object index. Accordingly, the access history register 45 outputs access history corresponding to the index (access object index). The decoder 47 decodes the index part of the address of the access destination in a similar manner, the access history register 45 outputs an access history in accordance with the decoded index, and the selector 46 selects the access history output from the access history register 45. The access history selected by the selector 46 is supplied to the power save unit 28 and stored in the temporary storage register 41.

When the way ID of the hit way is supplied from the match determining unit 25, the selectors 42-1 through 42-3 select three way IDs from the four way IDs, so that ways other than the hit way are selected. The selected three way IDs and the way ID of the hit way are stored in the temporary storage register 43, and are further written in the access history register 45. As described above, the access history held by the access history register 45 is updated based on the way ID of the hit way from the match determining unit 25.

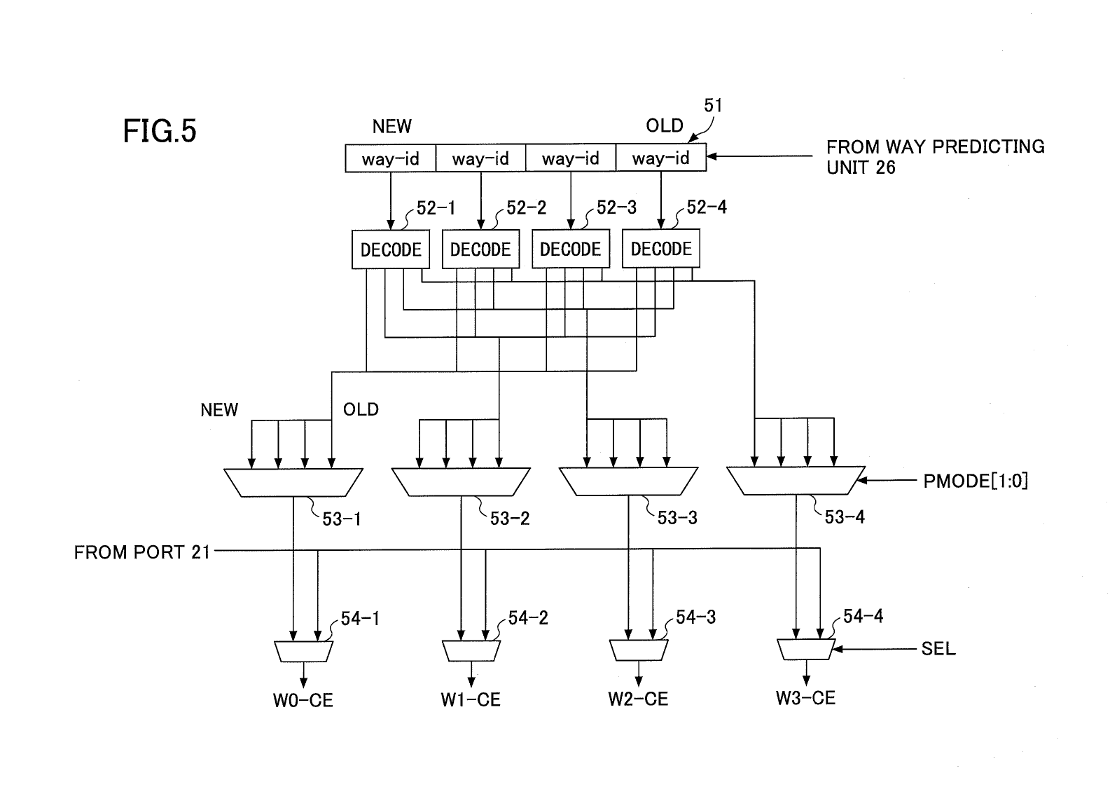

FIG. 5 illustrates an example of a configuration of the power save unit 28. The power save unit 28 includes a temporary storage register 51, decoders 52-1 through 52-4, selectors 53-1 through 53-4, and selectors 54-1 through 54-4. The temporary storage register 51 stores four way IDs of the access history supplied from the way predicting unit 26. The decoders 52-1 through 52-4 respectively decode the corresponding way IDs (two bits), and assert output signal lines corresponding to the numbers indicated by the way IDs among the four output signal lines. The remaining three output signal lines are put in a negate state. That is to say, each of the decoders 52-1 through 52-4 asserts only the “n”th output signal line from the left, when the input way ID indicates “n”th (n=1 through 4).

Each of the selectors 53-1 through 53-4 selects one more input signal lines among the four input signal lines corresponding to the order of four access times. Specifically, in a state where the number N of input signal lines to be selected is specified by a power save mode signal PMODE[1:0], an N number of input signal lines of new accesses (that have been most recently accessed) are selected. In each of the selectors 53-1 through 53-4, the four input signal lines connected to the input are arranged in an order of accessed time, with the newest access at the left. For example, the selector 53-1 corresponds to the way W0 of the cache RAM 30-1, and the four input signal lines indicate the order in which the way W0 has been accessed. That is to say, if the way W0 has been accessed “k”th from the last way among the four ways, the “k”th input signal line from the left is “1”, and the remaining input signal lines are “0”. When the power save mode signal PMODE[1:0] indicates N (N=1 through 4), each of the selectors 53-1 through 53-4 selects the Nth input signal line from the left, and outputs an OR value of the signal value of the selected signal line.

The selectors 54-1 through 54-4 respectively select the output of the selectors 53-1 through 53-4 and output the selection, in the first cache reading operation that is not after aborting.

In the second cache reading operation after aborting, the selectors 54-1 through 54-4 select a way ID from the port 21 and output the selection.

The power save unit 28 respectively supplies the chip enable signals W0-CE, W1-CE, W2-CE, and W3-CE (WAY[0:3]CE of FIG. 2) to the cache RAMs 30-1 through 30-4. Accordingly, the selected N number of ways are operated, and the ways other than the selected ways are put in a non-operation state.

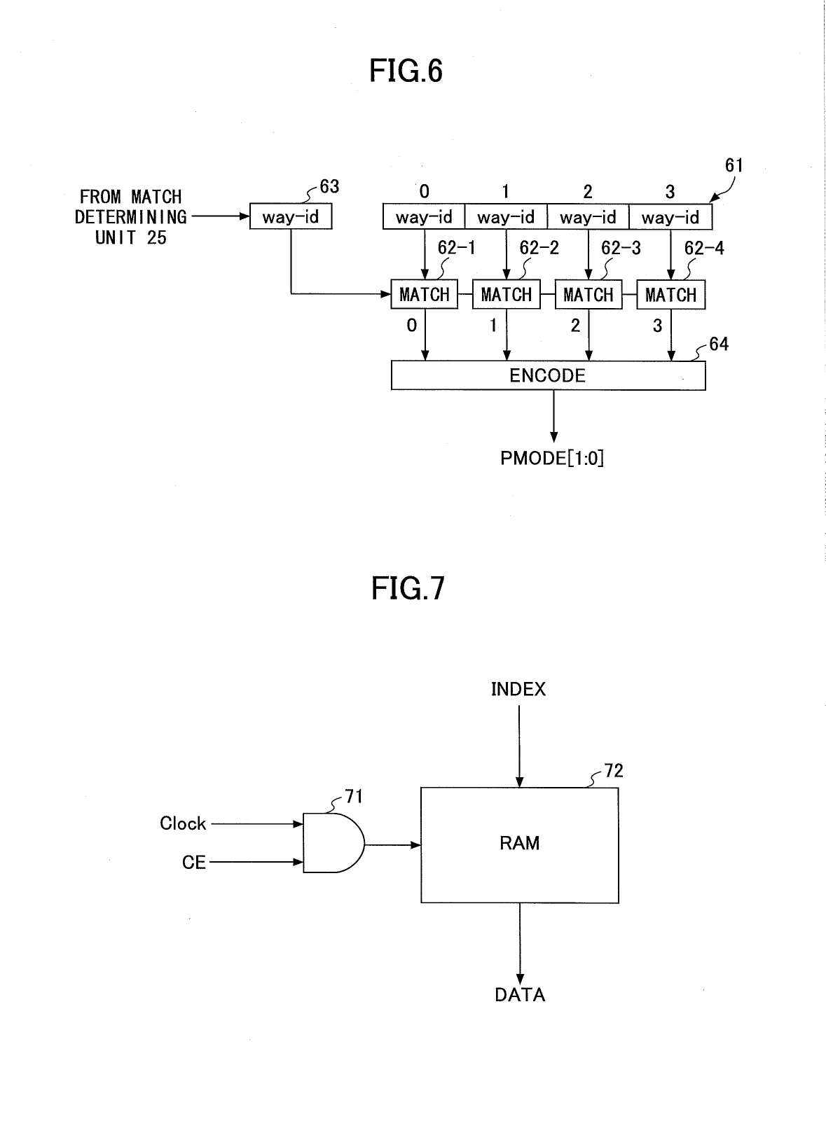

FIG. 6 illustrates an example of a configuration of the mode determining unit. The mode determining unit includes a temporary storage register 61, match circuits 62-1 through 62-4, a temporary storage register 63, and an encoder 64. The temporary storage register 61 stores four way IDs which are the access history of the access object index supplied from the way predicting unit 26. The temporary storage register 63 stores the way ID of the hit way supplied from the match determining unit 25. Each of the match circuits 62-1 through 62-4 compares the way ID of the corresponding access history with the way ID of the hit way, and asserts output when these way IDs match as a result of the comparison. Among the four outputs from the match circuits 62-1 through 62-4, only one output corresponding to the hit way is put in an assert state. The four way IDs stored in the temporary storage register 61 are arranged in an order of accessed time, with the newest access at the left, and therefore the assert output of the match circuits 62-1 through 62-4 indicate the order in which the hit way has been accessed last. That is to say, the assert output of the match circuits 62-1 through 62-4 identifies the ranking (for example, “M”th way) of the hit way defined by the access request, from the newest access time in the arrangement order of way IDs in the temporary storage register 61 (arrangement order indicated by access history). The encoder 64 encodes the output of the match circuits 62-1 through 62-4, to output the power save mode signal PMODE[1:0] indicating the identified number “M”.

FIG. 7 illustrates an example of operation control of the cache RAM. In FIG. 7, a control signal CE is a chip enable signal generated by the power save unit 28. This control signal CE may be applied to the chip enable input of a RAM 72, to directly control the operation and non-operation of the RAM 72. Alternatively, as illustrated in FIG. 7, the logical AND may be performed by an AND gate 71 between the control signal CE and the clock signal Clock, and the result of AND may be supplied to the RAM 72 as a clock signal. That is to say, the clock signal may be supplied to and may stop being supplied to the RAM 72 according to control by the control signal CE.

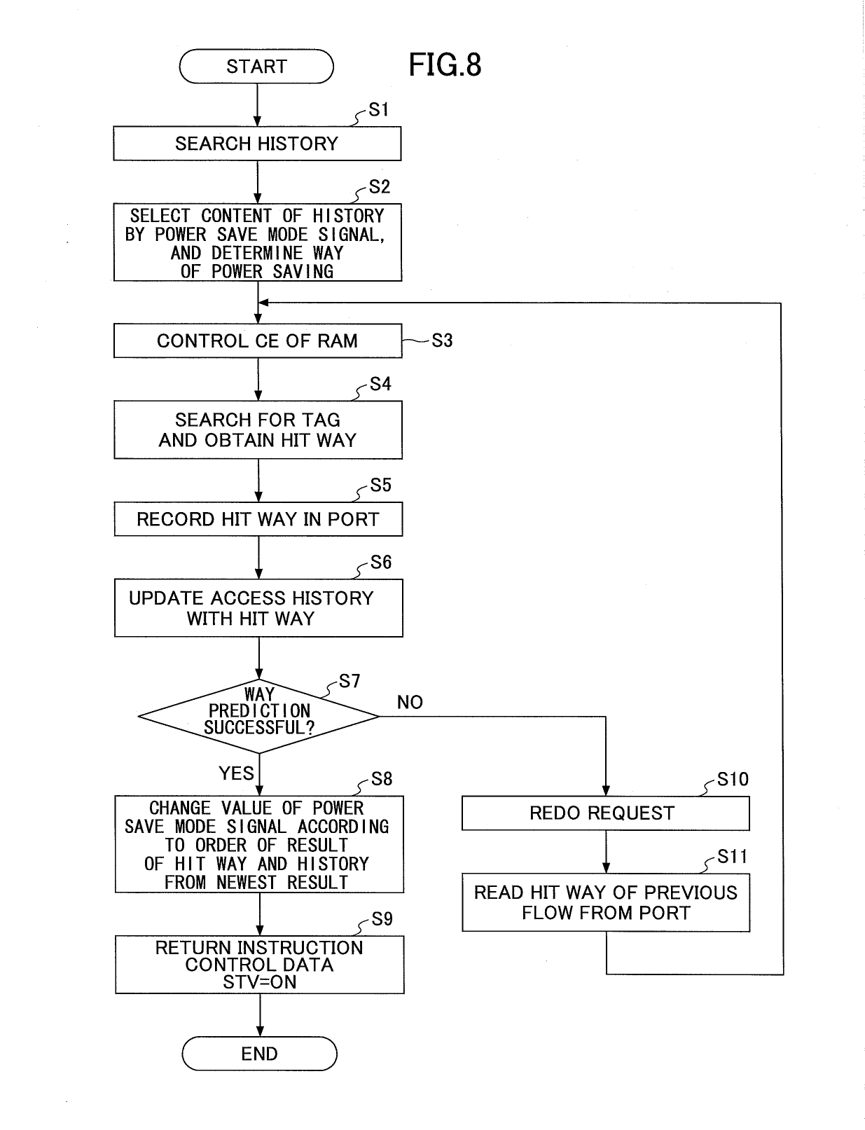

FIG. 8 is a flowchart indicating an example of the operation of the instruction cache 12. In step S1, the instruction cache 12 searches the history. That is to say, the instruction cache 12 extracts access history of the access object index from the access history register 45 of the way predicting unit 26. In step S2, the instruction cache 12 selects one or more ways from the extracted access history, based on a power save mode signal. The ways other than the selected way become the objects of power-saving. In step S3, the instruction cache 12 controls the chip enable signals CE of the cache RAMs 30-1 through 30-4. In step S4, the instruction cache 12 searches the tag unit 24 and identifies the hit way. In step S5, the instruction cache 12 records a way ID indicating the hit way in the port 21. In step S6, the access history is updated according to the hit way.

In step S7, the instruction cache 12 determines whether the way prediction is successful. That is to say, the instruction cache 12 determines whether the prediction by the prediction hit determining unit 27 is hit. When the prediction is successful (YES in step S7), in step S8, the mode determining unit changes the value of the power save mode signal according to the ranking of the hit way from the newest way in the access history. In step S9, the instruction cache 12 returns the data to the instruction control unit 11. At this time, the STV signal from the abort report unit 29 is asserted.

When the prediction is unsuccessful (NO in step S7), in step S10, the instruction cache 12 executes the request again. That is to say, in step S11, the instruction cache 12 reads the hit way of the access process in which the prediction is unsuccessful from the port 21, and executes step S3 and onward again.

According to an aspect of the embodiments, a memory device is provided, by which the maintenance of performance and the reduction of power consumption are balanced.

The present invention is not limited to the specific embodiments described herein, and variations and modifications may be made without departing from the scope of the present invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A memory device comprising:
a plurality of ways;
a register configured to hold an access history of accessing the plurality of ways; and
a way control unit configured to
select one or more ways among the plurality of ways according to an access request and the access history,
put the selected one or more ways in an operation state, and
put one or more of the plurality of ways other than the selected one or more ways in a non-operation state, wherein
the way control unit dynamically changes a number of the one or more ways to be selected, according to the access request.

2. The memory device according to claim 1, further comprising:
a match determining unit configured to identify a hit way that matches an access destination among the plurality of ways, according to the access request; and
a mode determining unit configured to determine the number of the one or more ways to be selected, according to the access history and the hit way.

3. The memory device according to claim 2, wherein
the access history includes arrangement order information indicating an arrangement order in a case where the plurality of ways are arranged in an order according to an access time indicating when each of the plurality of ways has been accessed last, and
the mode determining unit is configured to identify a ranking of the hit way in the arrangement order from a way of a newest access time, and set a number corresponding to the identified ranking as the number of the one or more ways to be selected.

4. The memory device according to claim 2, wherein
the way control unit selects the one or more ways before the match determining unit identifies the hit way.

5. A processor comprising:
an instruction control unit;
a computing unit; and
a cache memory, wherein
the cache memory includes
a plurality of ways,
a register configured to hold an access history of accessing the plurality of ways, and
a way control unit configured to
select one or more ways among the plurality of ways according to an access request from the instruction control unit and the access history,
put the selected one or more ways in an operation state, and
put one or more of the plurality of ways other than the selected one or more ways in a non-operation state, wherein
the way control unit dynamically changes a number of the one or more ways to be selected, according the access request.

6. A cache memory control method comprising:
extracting an access history corresponding to an access object index, from data indicating, for each index, a history of past access to a plurality of ways;
selecting one or more ways among the plurality of ways based on the access history;
putting the selected one or more ways in an operation state and putting one or more of the plurality of ways other than the selected one or more ways in a non-operation state;
reading one or more data items from each of the one or more ways in the operation state;
identifying a hit way by referring to a tag according to the access object index;
selecting one data item among the one or more data items that have been read, according to the identified hit way; and
changing a number of the one or more ways to be selected according to the hit way.
